(19) United States
(12) Patent Application Publication
(10) Pub. No.: US 2019/0184261 A1
(43) Pub. Date: Jun. 20, 2019

(54) PERSONALIZED DENTAL GUARDS

(71) Applicant: Leto R&D Corporation, Closter, NJ (US)

(72) Inventor: Hye Seong Son, Closter, NJ (US)

(73) Assignee: Leto R&D Corporation, Closter, NJ (US)

(21) Appl. No.: 15/846,863

(22) Filed: Dec. 19, 2017

(51) Int. Cl. A63B 71/08

(52) U.S. Cl. CPC A63B 71/085; G10D 9/00

(57) ABSTRACT

Personalized dental guards for users of musical wind instrument, as well as methods for making such personalized dental guards, are disclosed. The personalized dental guards can be fabricated from a thermoplastic ingot that becomes pliable at elevated temperatures. The method can involve heating the thermoplastic ingot until pliable, wrapping the pliable thermoplastic ingot around a musical wind instrument user's teeth to form a personalized dental guard that substantially conforms to the user's teeth. Once formed, the personalized dental guard can be transformed back to the pliable thermoplastic ingot by subjecting it to heat and the recovered thermoplastic ingot can be reprocessed to fabricate a new personalized dental guard.

The present disclosure relates generally to dental guards for users of musical wind instruments. Specifically, the present disclosure relates to personalized dental guards and methods for making the same.

### BACKGROUND OF THE DISCLOSURE

A musical wind instrument, such as a woodwind or a brasswind instrument, typically includes a resonator and a mouthpiece. The mouthpiece facilitates the flow of air from a user's mouth to the resonator to generate various tones. One of the most important aspects of playing a musical wind instrument involves formation of an embouchure, wherein the lips and teeth, particularly the maxillary central incisors, of the user engage with the mouthpiece to ensure proper funneling of air through the mouthpiece to the resonator. Specifically, formation of the embouchure requires the user to shape their lips according to a shape of the mouthpiece, rest their upper teeth on the mouthpiece, and fold their lower lip against their bottom teeth with the teeth bisecting approximately the middle of the fleshy part of the lower lip, while playing the musical wind instrument. However, pressure is often exerted by the user's upper teeth against the mouthpiece resulting in stress that can traumatize the user's teeth and damage the mouthpiece. Depending on the duration and the magnitude of the pressure exerted, the user's teeth can be worn, chipped, or fractured. In some cases, the user may experience pain, loosening, or shifting of their teeth. Additionally, vibrations generated while playing the musical wind instrument can also contribute to discomfort and damage the user's teeth. Furthermore, damage to the user's lower lip can occur as the result of the user's lower teeth touching and rubbing against the inside of the user's lower lip. Accordingly, there exists a need to address the foregoing problems associated with playing musical wind instruments.

### EMBODIMENTS OF THE INVENTION

One embodiment according to the present disclosure is a method for making a personalized dental guard for a user of a musical wind instrument the method comprising heating a thermoplastic ingot to form a pliable thermoplastic, wrapping the pliable thermoplastic ingot around the teeth of the user to form a dental guard, applying pressure to the dental guard to substantially conform a portion of the dental guard to the shape of the teeth of the user, cooling the dental guard to form a rigid dental guard, and removing the rigid dental guard from the user's teeth.

Another embodiment according to the present disclosure is a personalized dental guard prepared by a method comprising heating a thermoplastic ingot to form a pliable thermoplastic, wrapping the pliable thermoplastic ingot around the teeth of the user to form a dental guard, applying pressure to the dental guard to substantially conform a portion of the dental guard to the shape of the teeth of the user, cooling the dental guard to form a rigid dental guard, and removing the rigid dental guard from the user's teeth.

In certain embodiments according to the present disclosure, the teeth of the user are maxillary or mandibular teeth. In certain embodiments according to the present disclosure, a tape can be applied to the teeth of the user prior to wrapping the pliable thermoplastic ingot around the teeth of the user. In certain embodiments according to the present disclosure, the thermoplastic ingot comprises a film that covers at least a portion of a face of the thermoplastic ingot.

In certain embodiments according to the present disclosure, the method further comprises the step of applying pressure to an outer bottom surface of the dental guard by biting onto a mouthpiece of a musical wind instrument so as to substantially conform a portion of the dental guard to a curvature of the mouthpiece. In certain embodiments according to the present disclosure, the method further comprises the step of applying pressure to an outer bottom surface of the dental guard by biting onto a mouthpiece patch for a mouthpiece of a musical wind instrument so as to substantially conform a portion of the dental guard to a curvature of the mouthpiece patch. In certain embodiments according to the present disclosure, the mouthpiece patch comprises a recess and the method further comprises applying pressure to the outer bottom surface of the wrapped thermoplastic ingot by biting onto the mouthpiece patch so as to form a ridge complementary in shape to the recess of the mouthpiece patch. In certain embodiments according to the present disclosure, the method can further comprise repeating all of the aforementioned steps.

In certain embodiments according to the present disclosure, the heating comprises subjecting the thermoplastic ingot to a heated water bath. In certain embodiments according to the present disclosure, the thermoplastic ingot is a strip having a thickness of about 1 mm to about 3 mm. In certain embodiments according to the present disclosure, he thermoplastic ingot comprises a thermoplastic selected from the group consisting of polycaprolactones, poly(ethylene-vinyl acetates), polyurethanes, polystyrenes, poly(methyl methacrylates), and any combination and copolymers thereof.

In certain embodiments according to the present disclosure, an inner bottom surface of the personalized dental guard substantially conforms to the teeth of a user. In certain embodiments according to the present disclosure, an outer bottom surface of the personalized dental guard substantially conforms to a curvature of a mouthpiece of a musical wind instrument. In certain embodiments according to the present disclosure, the outer bottom surface of the personalized dental guard comprises a rib formed by applying pressure to the outer bottom surface of the dental guard by biting onto a mouthpiece patch having a recess and which is positioned on a mouthpiece of a musical wind instrument.

Yet another embodiment according to the present disclosure is a kit for making a personalized dental guard comprising a thermoplastic ingot capable of becoming pliable upon heating, a tape for applying to the teeth of a user, and a mouthpiece patch for a musical wind instrument, wherein the mouthpiece patch comprises a recessed region configured to receive the teeth of a user.

Yet another embodiment according to the present disclosure is a kit for making a personalized dental guard comprising a thermoplastic ingot capable of becoming pliable upon heating, wherein the thermoplastic ingot comprises a film that covers a least a portion of a face of the thermoplastic ingot and a mouthpiece patch for a musical wind instrument, wherein the mouthpiece patch comprises a recessed region configured to receive the teeth of a user.

### BRIEF DESCRIPTION OF THE SEVERAL VIEWS OF THE DRAWING

The foregoing summary, as well as the following detailed description of the exemplary embodiments of the invention, will be better understood when read in conjunction with the appended drawings. For the purpose of illustrating the subject disclosure, there are shown in the drawings exemplary embodiments. It should be understood, however, that the exemplary embodiments are not limited to the precise arrangements and instrumentalities shown.

In the drawings:

FIG. 1A is a perspective view of a thermoplastic ingot in accordance with embodiments of the present disclosure.

FIG. 1B is a perspective view of a thermoplastic ingot in accordance with embodiments of the present disclosure.

FIG. 2 is a perspective view of a tape in accordance with embodiments of the present disclosure.

FIG. 3A is a perspective view of a personalized dental guard in accordance with embodiments of the subject disclosure.

FIG. 3B is perspective view of a personalized dental guard in accordance with embodiments of the present disclosure;

FIG. 4 is a perspective view of a mouthpiece assembly for a musical wind instrument.

FIG. 5 is a flowchart of a method for making the personalized dental guard in accordance with embodiments of the present disclosure.

FIG. 6 is a perspective view of a personalized dental guard in accordance with embodiments of the subject disclosure.

### DETAILED DESCRIPTION OF THE INVENTION

Reference will now be made in detail to the exemplary embodiments of the invention illustrated in the accompanying drawings. It should be noted that the drawings are in simplified form and are not drawn to precise scale. In reference to the disclosure herein, for purposes of convenience and clarity only, directional terms such as top, bottom, above, below, and diagonal, are used with respect to the accompanying drawings. Such directional terms used in conjunction with the following description of the drawings should not be construed to limit the scope of the subject disclosure in any manner not explicitly set forth. Additionally, the term “a,” as used in the present specification, means “at least one.” The terms “right,” “left,” “top,” “bottom,” “front” “rear” “anterior,” and “posterior” are used throughout the present specification for convenience and it should be understood that these terms are not intended to be limiting. The terms “right,” “left,” “top,” “bottom,” “front” and “rear” designate directions in the drawings to which reference is made. The terminology includes the words above specifically mentioned, derivatives thereof, and words of similar import.

With reference to a personalized dental guard the “bottom surface” refers to a surface that is distal from root of a tooth, proximal to an incisal edge and in contact with the biting surface of a tooth. With reference to both a mouthpiece patch and a mouthpiece, the “anterior” refers to an end towards the tip of the mouthpiece, which is placed partly inside a user's mouth.

The term “about,” as used herein, when referring to a measurable value such as an amount, a temporal duration, and the like, is meant to encompass variations of ±20%, ±10%, ±5%, ±1%, and ±0.1% from the specified value, as such variations are appropriate.

Throughout this disclosure, various aspects of the exemplary embodiments can be presented in a range format. It should be understood that the description in range format is merely for convenience and brevity and should not be construed as an inflexible limitation on the scope of the subject disclosure. Accordingly, the description of a range should be considered to have specifically disclosed all the possible subranges, as well as individual numerical values within that range. For example, the description of a range “from 1 to 6” should be considered to have specifically disclosed all possible subranges falling within this range, such as from 1 to 3, from 1 to 4, from 1 to 5, from 2 to 4, from 2 to 6, from 3 to 6, etc., as well as all individual numbers falling within this range, e.g., 1, 2, 2.7, 3, 4, 5, 5.3, and 6. This applies regardless of the breadth of the range.

“Substantially” as used herein shall mean considerable in extent, largely, but not wholly, that which is specified, or an appropriate variation therefrom as is acceptable within the field of art.

Furthermore, the described features, advantages, and characteristics of the embodiments of the present disclosure may be combined in any suitable manner in one or more further embodiments. One skilled in the relevant art will recognize, in light of the description herein, that the subject disclosure can be practiced without one or more of the specific features or advantages of a particular exemplary embodiment. In other instances, additional features and advantages may be recognized in certain embodiments that may not be present in all embodiments of the subject disclosure.

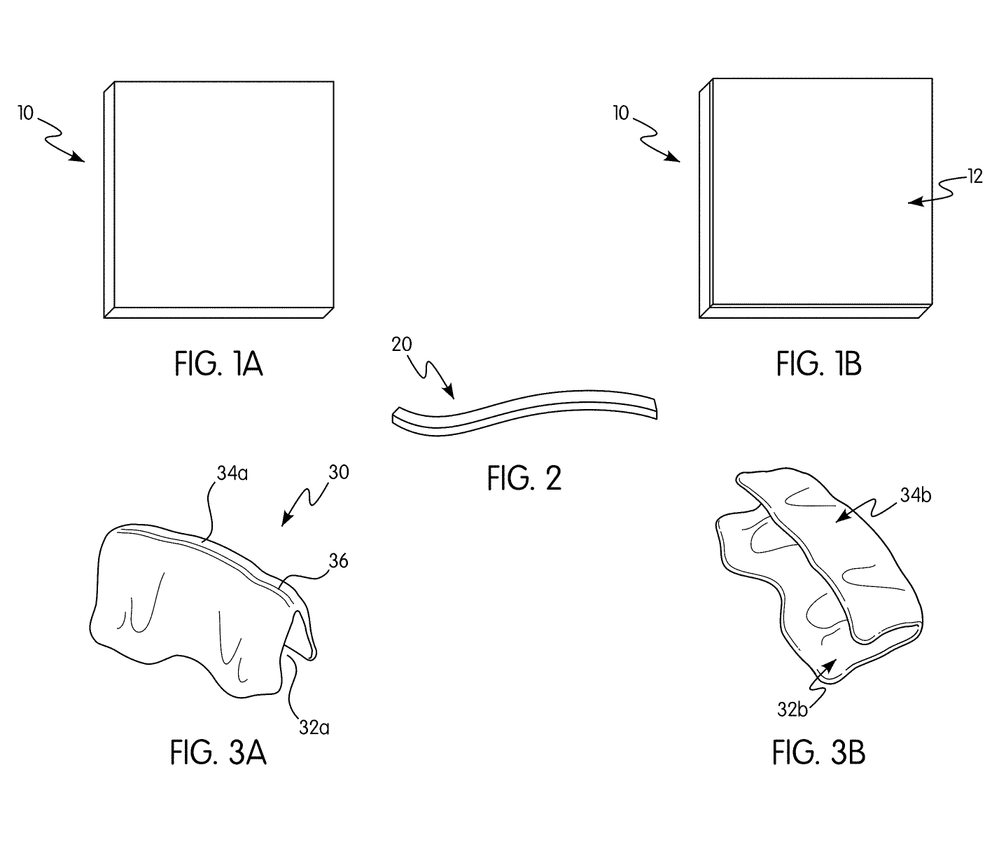

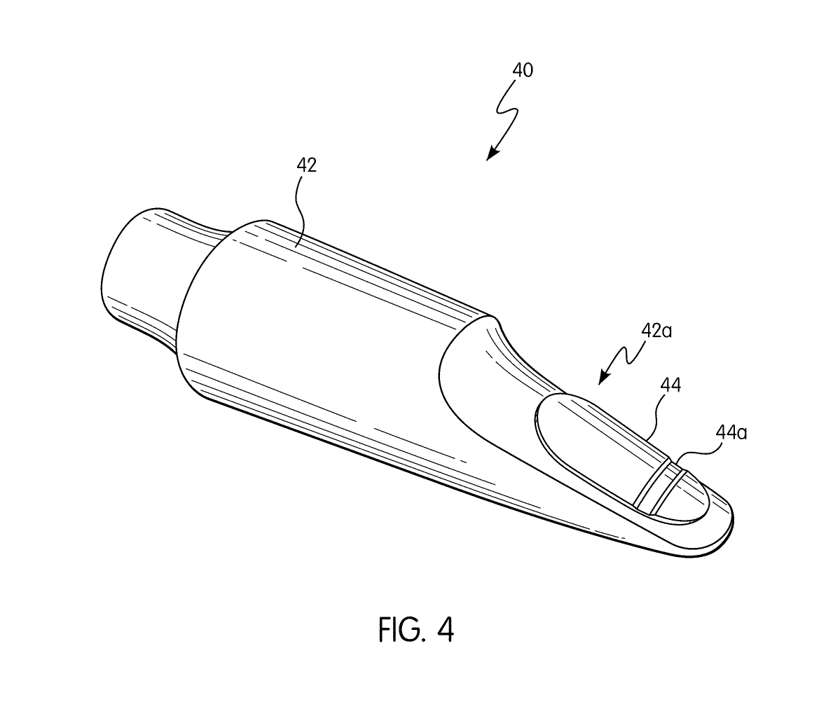

Referring now to the drawings, FIGS. 1A, 1B, 2, 3A, and 3B illustrate individual components of kits according to the present disclosure for making personalized dental guards for users of musical wind instrument. In certain embodiments, such kits can include a thermoplastic ingot 10 of FIG. 1A, a tape 20 of FIG. 2, and a mouthpiece patch 44 of FIG. 4. In certain other embodiments, such kits can include a thermoplastic ingot 10 of FIG. 1B having a barrier film 12 adhered to the surface of one of its faces and a mouthpiece patch 44 of FIG. 4. The presence of the tape 20 or the barrier film 12 prevents the thermoplastic from penetrating gaps between the user's teeth and from seeping too far behind oral appliances such as braces as the pliable thermoplastic material of the ingot is molded to the user's teeth. The presence of the barrier film also assists in removal of the rigid personalized dental guard after cooling.

Referring to FIGS. 1A and 1B, the thermoplastic ingots 10 can be configured substantially as shown. The thermoplastic ingot 10 can be used to make a personalized dental guard 30 depicted in FIG. 3A. The thermoplastic ingots according to the present disclosure can be any suitable thickness that permits its formation into a personalized dental guard according to the present disclosure. In certain embodiments according to the present disclosure, the thermoplastic ingot 10 can be configured as a strip having a thickness of about 1 mm to about 3 mm. In certain other embodiments, the thickness of the thermoplastic ingot can be less than 1 mm or greater than 3 mm. Examples of such thicknesses include, but are not limited to 0.1, 0.5, 3.5, 4.0, 4.5, 5.0, 5.5, 6 mm, or more.

The thermoplastic ingot 10 according to the present disclosure becomes pliable at elevated temperatures. For example, when the thermoplastic ingot is fabricated from a polystyrene, heating the polystyrene to about 100° C. renders the polystyrene pliable since it enters the glass-transition temperature range for this material. Additionally, appearance of the thermoplastic ingot 10 can vary with varying temperatures. In certain embodiments of the present disclosure, the appearance of thermoplastic ingot 10 changes from a dense, white-colored ingot to a transparent, viscous form when heated.

The thermoplastic ingots according to the present disclosure and the personalized dental guards produced therefrom can be fabricated from and, thus, comprise any suitable thermoplastic material. Examples of such suitable thermoplastic materials include, but are not limited to polycaprolactones, poly(ethylene-vinyl acetates), polyurethanes, poly(methyl methacrylate), polystyrenes, and any combination and copolymers thereof.

Referring to FIG. 2, the tape 20 can be configured substantially as shown. The tape 20 can be configured to be applied to the teeth of users, such as users who have oral appliances, such as braces. The tape 20 is capable of sealing gaps between the user's teeth and/or between braces and the user's teeth such that the tape prevents the thermoplastic material of the ingot 10 from undesirably depositing in such gaps.

Referring to FIG. 4, an exemplary musical wind instrument mouthpiece assembly 40 comprising a musical instrument mouthpiece 42 and a mouthpiece patch 44 for the mouthpiece is shown. The mouthpiece patch 44 includes the recessed region 44a. The recessed region 44a is configured to receive the front teeth of the user, particularly the maxillary central incisors of the user. The mouthpiece patch is attached to the anterior top surface 42a of the mouthpiece 42.

Referring to FIGS. 3A and 3B, the personalized dental guard 30 is configured substantially as shown. The personalized dental guard 30 comprises an inner surface 32b and an outer surface 34b. The inner surface 32b includes an inner bottom surface 32a. Similarly, the outer surface 34b includes an outer bottom surface 34a. The inner surface 32b, when formed using the exemplary method described herein, substantially conforms to the shape of the user's teeth. Accordingly, the inner bottom surface 32a of the dental guard 30 is configured to conform to a biting surface of the user's teeth. The outer bottom surface 34a is configured to rest on a mouthpiece 42 while playing the musical wind instrument. Accordingly, the outer bottom surface 34a is configured to substantially conform to a curvature of an anterior top surface 42a of the mouthpiece 42. Alternatively, the outer bottom surface 34a can include a rib 36 configured to substantially conform to a recessed region 44a of a mouthpiece patch 44 for the mouthpiece 42.

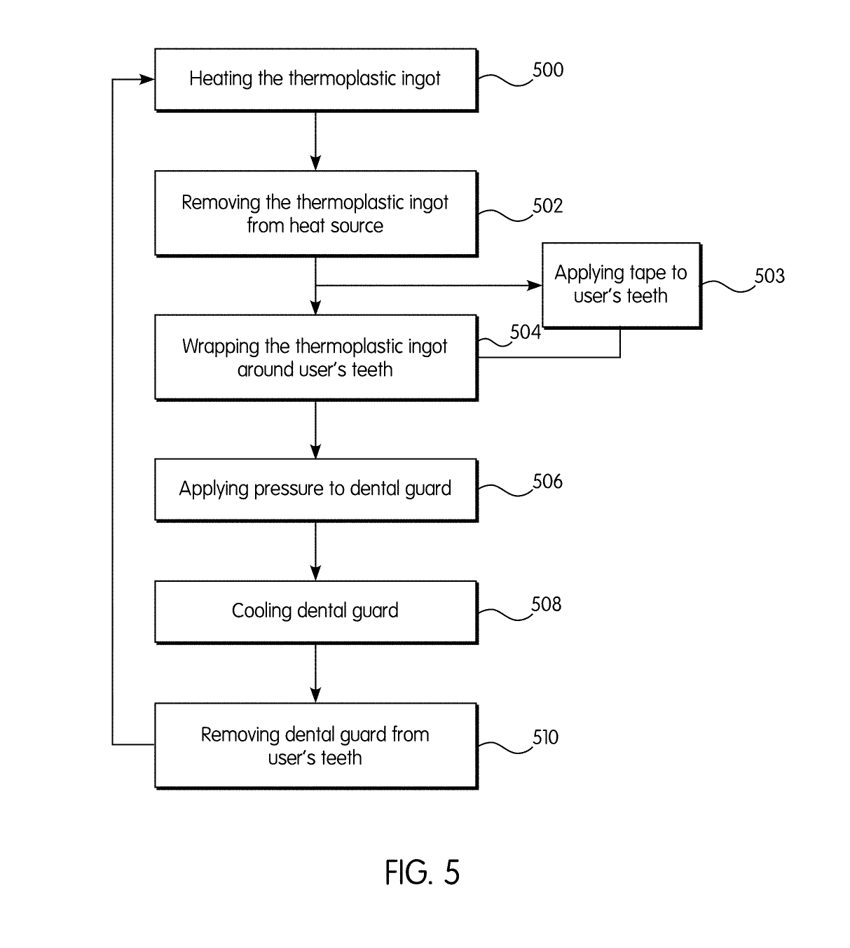

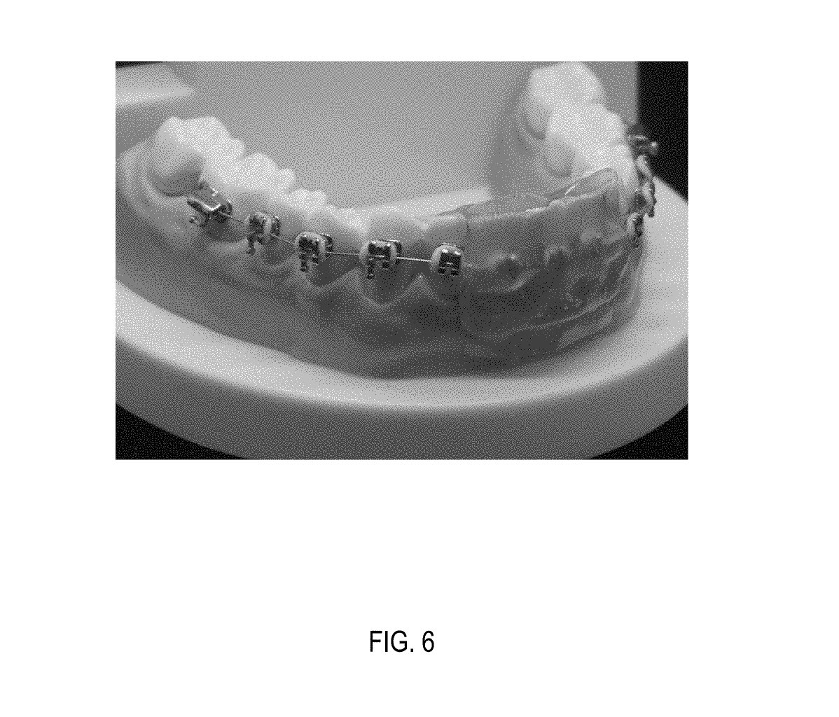

Referring to FIG. 5, a flowchart summarizing a method of making the personalized dental guard 30 depicted in FIG. 3A is shown. As described in step 500, the temperature of the thermoplastic ingot is elevated using a heating source. Any suitable heat source may be used to elevate the temperature of the thermoplastic ingot. Examples of such heat sources include, but are not limited to, hot water baths, heat guns, and ovens. When the thermoplastic ingot is sufficiently heated it becomes a pliable thermoplastic ingot. The pliable thermoplastic ingot is then withdrawn away from the heating (step 502).

In step 504, the pliable thermoplastic ingot is wrapped around a user's teeth, forming a pliable dental guard. The formed pliable dental guard is pressed manually such that the inner surface 32b conforms substantially to the user's teeth. Further, pressure is applied (step 506) to the pliable dental guard by biting onto the anterior top surface 42a of the mouthpiece 42 to substantially conform the outer bottom surface 34a of the dental guard 30 to a curvature of the mouthpiece 42. Alternatively, pressure can be applied to the pliable dental guard by biting onto the mouthpiece patch 44 to form a ridge 36 adjacent the outer bottom surface 34a such that the ridge is complementary in shape to the recess 44a of the mouthpiece patch. Further, the pliable dental guard is allowed to cool (step 508) and rigidify to form the personalized dental guard 30. The personalized dental guard 30 is then removed (step 510) from the user's teeth and can be worn by the user whenever required.

In certain embodiments according to the present disclosure, as shown in (step 503), tape 20 can be applied to the user's teeth prior to wrapping the pliable ingot around the user's teeth. The tape 20 can be easily peeled off from the surface of the personalized dental guard 30 once fabricated and cooled. In certain other embodiments according to the present disclosure, when thermoplastic ingots 10 comprising a barrier film 12 removably adhered the surface of a face of the ingot are used according to the presently disclosed methods, the thermoplastic ingot 10, after heating to pliability, is wrapped around the user's teeth such that the barrier film 12 is facing inward towards and/or in contact with the user's teeth.

Like the tape 20, the barrier film 12 is capable of sealing gaps between the user's teeth and/or between braces and the user's teeth such that the tape prevents the thermoplastic material of the ingot 10 from undesirably depositing in such gaps. Also, like the tape 20, the barrier film 12 can easily be peeled off from the surface of the personalized dental guard 30 once fabricated and cooled. In certain embodiments, the barrier film 12 can extend beyond the edge of the face of the thermoplastic ingot 10 to which it is removably adhered. In such embodiments, the extended edges of the barrier film 12, which can be gripped by hand or with a tool, advantageously aids in handling of the thermoplastic ingot 10 during heating and also during removal of the barrier film 12 after cooling. In certain other embodiments, the barrier film 12 can be contiguous with the edge of the face of the thermoplastic ingot 10 to which it is removably adhered.

In certain embodiments according to the present invention, the aforementioned method for making the personalized dental guard according to the present disclosure can be repeated by elevating the temperature of the personalized dental guard 30 to transform it back into a pliable thermoplastic ingot. This recovered pliable ingot can then be reprocessed as according to steps 500 through 510 in FIG. 5 to again fabricate a personalized dental guard.

Thus, the personalized dental guard 30 can be made such that when worn by the user while playing the musical wind instrument, the inner surface 32b of the personalized dental guard 30 is directly in contact with the user's teeth while the outer bottom surface 34a rests on the mouthpiece 42. When the mouthpiece patch 44 is attached to the mouthpiece 42, the recessed region 44a of the mouthpiece patch confines the outer bottom surface 34a of the dental guard 30, forming an interlocking system such that the user can properly position and maintain proper positioning of his/her mouth on the mouthpiece 42.

In operation, the personalized dental guard 30 serves as a protective interface between the user's upper teeth and the mouthpiece 42 or between the user's teeth and lips, particularly the user's lower teeth and lower lip. Thus, when pressure is exerted by the user's upper teeth on the mouthpiece or by the user's lower teeth on the user's lower lip, the impact of the resulting stress experienced by the user's upper teeth or lower lip is curtailed. Further, the mouthpiece patch 44, when used with the personalized dental guard 30, provides an additional layer of cushioning between the upper teeth and the mouthpiece 42 to dampen the conduction of vibrations, generated while playing the musical wind instrument, to the user's upper teeth. Thus, the dental guard 30 and the mouthpiece patch 44 together help to minimize the discomfort and protect the user's upper teeth from trauma while playing the musical wind instrument. Additionally, the recess 44a on the mouthpiece patch 44 confines the outer bottom surface 34a of the dental guard 30 to prevent sliding of the upper teeth on the mouthpiece patch, thereby helping the user to maintain proper positioning of his/her mouth on the mouthpiece 42. The proper positioning of the user's mouth on the mouthpiece 42 helps to form proper embouchure essential for efficiently playing the musical wind instrument

The various embodiments of the personalized dental guard and the method for making the personalized dental guards disclosed herein provide numerous advantages. For example, according to the method described in the present disclosure, the same ingot can be recycled and repeatedly used for casting and then recasting dental guards to adapt to the changes in dentition of the user over time or to rectify any deformations within the guard occurring over time, thereby making the personalized dental guards of the present disclosure an economically favorable option.

While the subject disclosure has been described with reference to exemplary embodiments, it will be appreciated by those skilled in the art that various changes may be made and equivalents may be substituted for elements thereof without departing from the scope of the present disclosure. For example, features or steps described in one embodiment may be incorporated into a different embodiment.

In addition, modifications may be made to adapt a particular situation or material to the teachings of the subject disclosure without departing from the essential scope thereof. For example, the dimensions including width, length, height, and shape of the thermoplastic ingot can be varied. It is to be understood, therefore, that the present disclosure is not limited to the particular aspects disclosed, but it is intended to cover modifications within the spirit and scope of the present disclosure as defined by the appended claims and discussed above.

I/We claim:

1. A method for making a personalized dental guard for a user of a musical wind instrument, the method comprising:
(a) heating a thermoplastic ingot to form a pliable thermoplastic ingot;
(b) wrapping the pliable thermoplastic ingot around the teeth of the user to form a dental guard;
(c) applying pressure to the dental guard to substantially conform a portion of the dental guard to the shape of the teeth of the user;
(d) cooling the dental guard to form a rigid dental guard; and
(e) removing the rigid dental guard from the teeth of the user.

2. The method of claim 1, wherein the teeth of the user comprise maxillary or mandibular teeth.

3. The method of claim 1, wherein a tape is applied to the teeth of the user prior to step (b).

4. The method of claim 1, wherein the thermoplastic ingot comprises a film that covers a least a portion of a face of the thermoplastic ingot and during step (b) the pliable thermoplastic ingot is wrapped around the teeth of the user such that the barrier film is facing inward towards and/or in contact with the teeth of the user.

5. The method of claim 1, further comprising the step of applying pressure to an outer bottom surface of the dental guard by biting onto a mouthpiece of a musical wind instrument so as to substantially conform the a portion of the dental guard to a curvature of the mouthpiece.

6. The method of claim 1, further comprising the step of applying pressure to an outer bottom surface of the dental guard by biting onto a mouthpiece patch so as to substantially conform a portion of the dental guard to a curvature of the mouthpiece patch.

7. The method of claim 6, wherein the mouthpiece patch comprises a recess, and further comprises the step of applying pressure by biting onto a mouthpiece patch so as to form a ridge complementary in shape to the recess of the mouthpiece patch.

8. The method of claim 1, further comprising repeating of the steps (a)-(e).

9. The method of claim 1, wherein the heating comprises subjecting the thermoplastic ingot to a heated water bath.

10. The method of claim 1, wherein the thermoplastic ingot is a strip having a thickness of about 1 mm to about 3 mm.

11. The method of claim 1, wherein the thermoplastic ingot comprises a thermoplastic selected from the group consisting of polycaprolactones, poly(ethylene-vinyl acetates), polyurethanes, polystyrenes, poly(methyl methacrylates), and any combination and copolymers thereof.

12. A personalized dental guard prepared by the method of claim 1.

13. The personalized dental guard of claim 11, wherein an inner bottom surface substantially conforms to the teeth of a user.

14. The personalized dental guard of claim 11, wherein an outer bottom surface substantially conforms to a curvature of a mouthpiece of a musical wind instrument.

15. The personalized dental guard of claim 11, wherein the outer bottom surface comprises a rib formed by applying pressure to the outer bottom surface of the dental guard by biting onto a mouthpiece patch having a recess and which is positioned on a mouthpiece of a musical wind instrument.

16. The personalized dental guard of claim 11, wherein the thermoplastic ingot comprises a film that covers a least a portion of a face of the thermoplastic ingot

17. The personalized dental guard of claim 11, wherein the thermoplastic ingot is a strip having a thickness of about 1 mm to about 3 mm.

18. The personalized dental guard of claim 11, wherein the thermoplastic ingot comprises a thermoplastic selected from the group consisting of polycaprolcatones, poly(ethylene-vinyl acetates), polyurethanes, polystyrenes, poly(methyl methacrylates), and any combination and copolymers thereof.

19. A kit for making a personalized dental guard comprising:
a thermoplastic ingot capable of becoming pliable upon heating;
a tape for applying to the teeth of a user; and
a mouthpiece patch for a musical wind instrument, wherein the mouthpiece patch comprises a recessed region configured to receive the teeth of a user.

20. A kit for making a personalized dental guard comprising:
a thermoplastic ingot capable of becoming pliable upon heating, wherein the thermoplastic ingot comprises a film that covers a least a portion of a face of the thermoplastic ingot; and
a mouthpiece patch for a musical wind instrument, wherein the mouthpiece patch comprises a recessed region configured to receive the teeth of a user.
